(19) United States
(12) Patent Application Publication
(10) Pub. No.: US 2012/0202402 A1
(43) Pub. Date: Aug. 9, 2012

(54) Composite Structure Using Chenille Stem and Inflated Balloon

(76) Inventor: William Paul Slivinski, Nashua, NH (US)

(21) Appl. No.: 13/022,108

(22) Filed: Feb. 7, 2011

(51) Int. Cl. A63H 3/06; B23P 17/04

(52) U.S. Cl. 446/223; 29/428

(57) ABSTRACT

A composite structure based from an inflated balloon and a chenille stem. The composite structure has the chenille stem attached to the inflated balloon to create enhancements to replicate real-world or fantasy items. A method for assembling the composite structure. A kit for assembling the composite structure.

### BACKGROUND OF THE INVENTION

1. Field of the Invention

The present invention relates generally to entertainment items. More particularly, the present invention relates to a composite structure using chenille wire and inflated balloons.

2. Description of Related Art

Balloons and other inflatable items are widely distributed for many different forms of entertainment and are provided at various events. In some cases entertainers are hired to create twisted and sculpted balloons. In other cases balloon sculpting and similar crafts are engaged in as a relaxing and entertaining activity. Craft activities, where people participate during events, for example, showers, birthdays and club meetings are popular and desirable. In other cases, balloon and other inflatable items are pre-manufactured.

This balloon sculpting however, involves only one balloon or a set of balloons. Balloons, by their nature, are somewhat difficult to work with, are limited in the structures they can create, are often too fragile to play with, and the item that they are sculpted to resemble is often hard to decipher.

Attempts have been made to overcome the above-noted disadvantages of conventional balloon sculpting. US Pat. Pub. No. US 2007/0079404 A1 discloses a balloon figure resembling a baby and method for making the same. A kit for the balloon baby comprises instructions for constructing the balloon baby, a plurality of long slender balloons, at least two of which to be at least partially inflated, a round balloon to be at least partially inflated and attached to one of the partially inflated long slender balloons, and a hollow container.

U.S. Pat. No. 4,662,157 discloses an inflated suspended dancing toy, which is a device embodying an inflatable head or body, with bellows-type arms and legs and a cap or head piece adhesively secured to the head and having means for securing a string or thread to the cap or head piece so that the device may be suspended and then actuated. This device is manufactured and provided to the consumer already assembled.

Therefore, what is needed is an inflatable composite balloon structure that can be easily constructed, can create a wide variety of structures resembling real-life items with minimal materials, and that can be created and used in a way that is entertaining, can be played with, and modified, without a complex manufacturing process.

### SUMMARY OF THE INVENTION

The subject matter of this application may involve, in some cases, interrelated products, alternative solutions to a particular problem, and/or a plurality of different uses of a single system or article.

In one aspect, a composite structure is provided. This composite structure comprises an inflated balloon body and a chenille stem being attached to a surface portion of the balloon body. The chenille stem being shaped to resemble an enhancement.

In another aspect, a method of constructing a composite structure is provided. This method involves the steps of inflating a balloon body with an inflation fluid, attaching a chenille stem about a circumference of the balloon body by twisting a first portion of the chenille stem about a second portion of the chenille stem, imprinting at least one facial feature onto a surface of the balloon body, and shaping an end portion of the chenille stem to resemble an enhancement.

In yet another aspect, a kit for constructing a composite structure is provided comprising a balloon body, a chenille stem capable of attachment to the balloon body, and an instruction manual containing instructions for attachment of the chenille stem to the balloon body.

### BRIEF DESCRIPTION OF THE DRAWINGS

FIG. 1A provides an illustration of a top view of an embodiment of a balloon body of a composite structure.

FIG. 1B provides an illustration of a perspective view of an embodiment of a balloon body of a composite structure.

FIG. 1C provides an illustration of a perspective view of an embodiment of a balloon body of a composite structure with a chenille stem.

FIG. 1D provides an illustration of a perspective view of an embodiment of a complete composite structure.

FIG. 2A provides an illustration of a frontal view of an embodiment of a composite structure.

FIG. 2B provides an illustration of a rear view of an embodiment of a composite structure.

FIG. 3A provides an illustration of a side view of an embodiment of a composite structure.

FIG. 3B provides an illustration of a perspective view of an embodiment of a composite structure.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a composite structural figure having at least one inflated balloon and at least one chenille stem attached to the balloon. Chenille stems and inflated balloons are commingled in such a manner that allows for attachment and substitution with each other to form composite structures.

It should be understood that the size and extent of inflation may vary depending on the use, function, and intended appearance of the composite structure. Further, it should be understood that the term “inflated” applies to all extents of inflation. The composite structure may be shaped and designed to form a wide variety of structures resembling animals, fanciful creatures, hats, flowers, fruit, trees, planes, bicycles, cars, airplanes, helicopters, or other vehicles, among others.

The composite structure achieves this by utilizing balloons of various shapes, sizes, and colors for use as a body for the structure, and utilizes chenille stems of various shapes, sizes and colors that are attached to the balloons as enhancements to enhance the entertainment value of the structures, as well as the variety, durability, and to create structural features that may not be as artistically viable using only balloons. These enhancements may include features such as arms, legs, hands, feet, wings, bodies, faces, skeletons, wheels, or flower stems, among others.

This composite structure so constructed may be used as a toy or entertainment object for play, educational use, as an arts and craft activity, decoration, or distributed at parties, graduations, anniversaries, club meetings, carnivals, fairs, weddings, baby and wedding showers, and trade shows, among other venues.

The balloon may vary in color, shape, size, and material depending on the structure to be made. The color, shape, size and material are critical when determining the impression and construction desired. Further, the amount of inflation of the balloon may vary, depending on the structure to be made.

The term chenille stem relates to a wire body that is somewhat flexible and formed by twisted wires on which fibers such as chenille are interwoven and held together by the twisted plies of the wire. The fibers may vary in size depending on the desired effective diameter of the chenille stem. The chenille stem may vary in color, effective diameter, length, and texture depending on the structure to be made. The color, effective diameter, length, and texture are critical when determining the impression and construction desired.

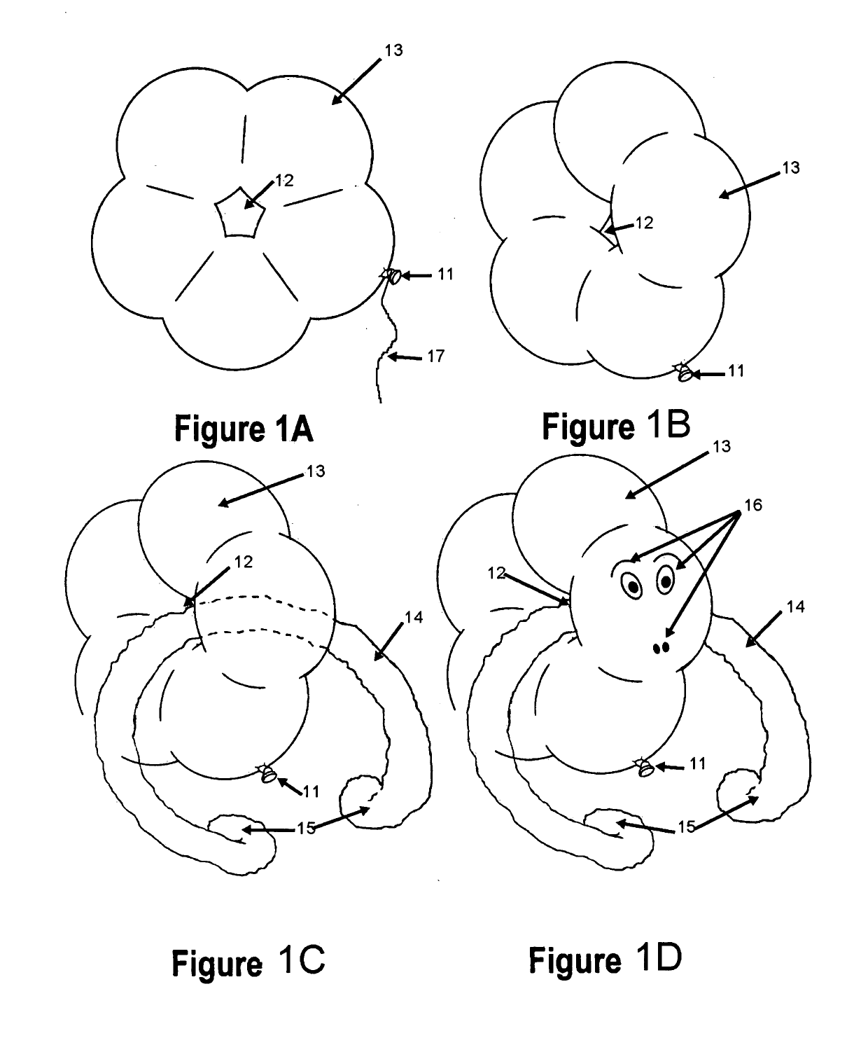

FIGS. 1A, 1B, 1C and 1D show multiple views of one embodiment of the composite structure. The composite structure has a balloon body, best shown in FIGS. 1A-1B as a blossom shaped body 13. Balloons such as the Geo Blossom balloon manufactured by Pioneer Balloon Company are commercially available to achieve this shape of balloon body. The blossom shaped body 13 is constructed as a bag made of thin latex, or other light material that is generally gas impermeable including but not limited to Mylar, or metallic coated film.

The blossom shaped body 13 defines an aperture 12 through the central axis of the blossom shaped body 13. The blossom shaped body 13 may be inflated during construction of the composite structure by the supply of an inflation fluid such as air, lighter-than-air gas such as helium or hydrogen, water or other liquid, or a combination of gasses, a combination of liquids, or liquids and gasses. This inflation fluid is introduced through a neck portion 11 of the blossom shaped body 13. The introduction of the inflation fluid may be performed manually by the user using air forced from the lungs, or by the aid of a pump, pressurized canister, water faucet or other similar device capable of moving a fluid with substantial pressure so as to inflate the balloon body.

The neck portion 11 is constructed and arranged as a section of the balloon body with a substantially narrowed diameter and defining an aperture providing fluid communication between an inside of the balloon and the atmosphere. The neck portion thus creates a small channel for the inlet and outlet of inflation fluid to the balloon body. The neck portion 11 is constructed and arranged such that it creates a channel extending from the balloon body that may be sealed, preventing escape of the inflation fluid by tying-off creating a knot, or balloon knot, fusing the neck portion 11 closed, or other sealing method capable of preventing a rapid escape of inflation fluid.

A facial portion 16 of the balloon body is located on an outer surface of the blossom shaped body 13. Facial features may be imprinted on this facial portion 16. Facial features imprinted on the facial portion 16 may include features such as hair, eyes, pupils, nose, mouth, eyebrows, and ears, among others. The facial portion 16 may have facial features imprinted on it manually by marker, pen, paint or other writing implement, or the features may be imprinted by being printed, screened, or sprayed onto the facial portion 16. The facial portion 16 may be imprinted either before inflation, or after.

A chenille stem 14 is inserted through the aperture 12 formed by the blossom shaped body 13. Preferably, the chenille stem 14 may be bent near the center of its length to create a central bend. This central bend may allow the chenille stem to be in the shape of an arc. Preferably the chenille stem 14 is sized and bent such that it fits snugly within the aperture 12 and can maintain its position against minor forces such as gravity because of the frictional forces between the chenille stem 14 and the walls of the blossom shaped body 13. This bending and positioning within aperture 12 allows the chenille stem 14 to rotate about an axis running through the aperture 12 of the blossom shaped body 13. Proper bending allows the chenille stem 14 to be rotatable and also to maintain its position once rotated. This central bending may be achieved by manual manipulation of the chenille stem 14 by a user, automated bending by machine, or the chenille stem 14 may be pre-formed during manufacture. In other embodiments, the chenille stem may be held in position using adhesives such as glue or tape.

The chenille stem 14 may be further bent at its ends to form features such as hands 15. This bending involves folding the ends of the chenille stem 14 inward in the same direction as the central bend. The hands 15 may be formed by manual manipulation by the user, automated bending by machine, or the chenille stem may be pre-formed during manufacture. In a further embodiment, the hands may be configured to hold an item (not shown), or to attach the composite structure to another item (not shown). The item held could be a wide variety of things, including other composite structures, and is limited only by the size of the hands 15 and the limitations of the chenille stem 14 used.

A string 17 may be attached to the composite structure. The string may be attached to any part of the composite structure, such as the blossom shaped body 13 itself, through the aperture 12 of the blossom shaped body 13, to the neck portion 11, to the chenille stem 14, or to the hands 15.

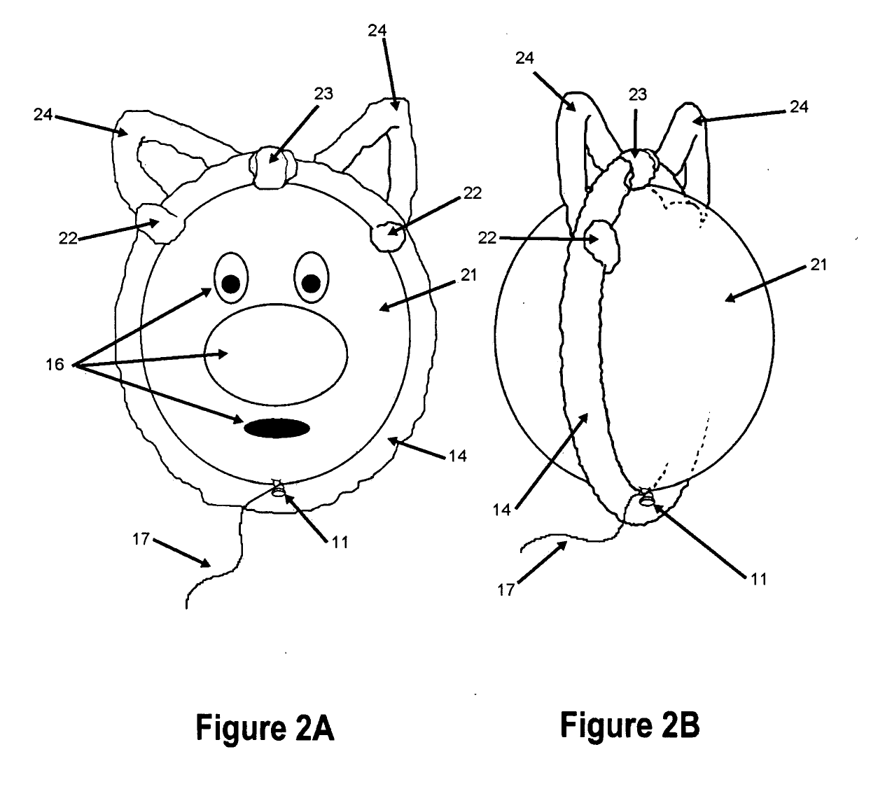

Referring now to FIGS. 2A and 2B, another embodiment of the present invention is shown. The composite structure may have a balloon body shown in FIGS. 2A-2B as a spherical body 21. It should be understood that the spherical body 21 may be substantially spherical, including shapes such as approximately spherical, generally round, or teardrop shaped without straying from the scope of the present invention. The spherical body 21 is constructed as a bag made of thin latex, or other light material including but not limited to Mylar, metallic coated film, or other thin, generally gas impermeable material.

The spherical body 21 may be inflated during construction of the composite structure by the supply of an inflation fluid such as air, lighter-than-air gas such as helium or hydrogen, water or other liquid, or a combination of gasses, a combination liquids, or liquids and gasses. This inflation fluid is introduced through a neck portion 11 of the spherical body 21. The introduction of the inflation fluid may be performed manually by the user using air forced from the lungs, or by the aid of a pump, pressurized canister, water faucet, or other similar device capable of moving a fluid with substantial pressure so as to inflate the balloon body.

The neck portion 11 is constructed and arranged as a section of the balloon body with a substantially narrowed diameter that defines an aperture providing fluid communication between an inside of the balloon body and the atmosphere. The neck portion thus creates a small channel for the inlet and outlet of inflation fluid to the balloon body. The neck portion 11 is constructed and arranged that creates a channel extending from the balloon body such that it may be sealed, preventing escape of the inflation fluid by tying-off creating a knot, or balloon knot, fusing the neck portion 11 closed, or other sealing method capable of preventing a rapid escape of inflation fluid.

A facial portion 16 of the balloon body is located on an outer surface of the spherical body 21. Facial features may be imprinted on this facial portion 16. Facial features imprinted on the facial portion 16 may include features such as hair, eyes, pupils, nose, mouth, eyebrows, and ears, among others. The facial portion 16 may have facial features imprinted on it manually by marker, pen, paint or other writing implement, or the features may be imprinted by being printed, screened, or sprayed onto the facial portion 16. The facial portion 16 may be imprinted either before inflation, or after.

A chenille stem 14 may be wrapped around a circumference of the spherical body 21. In the embodiment shown in FIGS. 2A-2B, the chenille stem 14 is shown wrapped around the greatest circumference of the spherical body 21. The length of the chenille stem 14 should be greater than the greatest circumference of the spherical body 21 to allow the chenille stem 14 to be secured to the spherical body 21. The chenille stem 14 is secured to the spherical body 21 by twisting two end portions of the chenille stem 14 about each other, forming a knot 23. The chenille stem 14 is thus held in place by the knot 23 and the friction caused by the outward pressure of the spherical body 21 against the chenille stem 14. The knot 23 may be formed by manual manipulation by the user, automated twisting by machine, the chenille stem 14 may be twisted to form a knot 23 during manufacture, or the chenille stem 14 may have a pre-formed region act as a knot 23, formed during manufacture. In alternate embodiments, the chenille stem 14 may be held in position using adhesives such as tape or glue.

Extending portions of the chenille stem 14 remaining after the formation of the knot 23 may be shaped to form features adding to the realism and effect of the composite structure. Features may include ears, horns, hair, a crown, a hat, or the like. FIGS. 2A-2B show ears 24, by way of example. These ears 24 may be formed by bending extending end portions of the chenille stem 14 by into substantially triangular or semi-circular shapes. Each end of the chenille stem 14 may then be attached to the length of the chenille stem at a connection point 22. This attachment may be done by wrapping or hooking the end of the chenille stem 14 to a length of the chenille stem 14 that is positioned along the spherical body 21. Thus providing a connection point 22. Attaching each end of the chenille stem 14 to the connection point 22 ensures that the ears 24 or other features remain in the proper shape and position. The ears 24 may be formed and secured by manual manipulation by the user, automated bending by machine, or the ears 24 may be pre-formed during manufacture of the chenille stem 14.

A string 17 may be attached to the composite structure. The string may be attached to any part of the composite structure, such as the spherical body 21 itself, to the neck portion 11, to the chenille stem 14, to the knot 23, connection point 22 or to the ears 24.

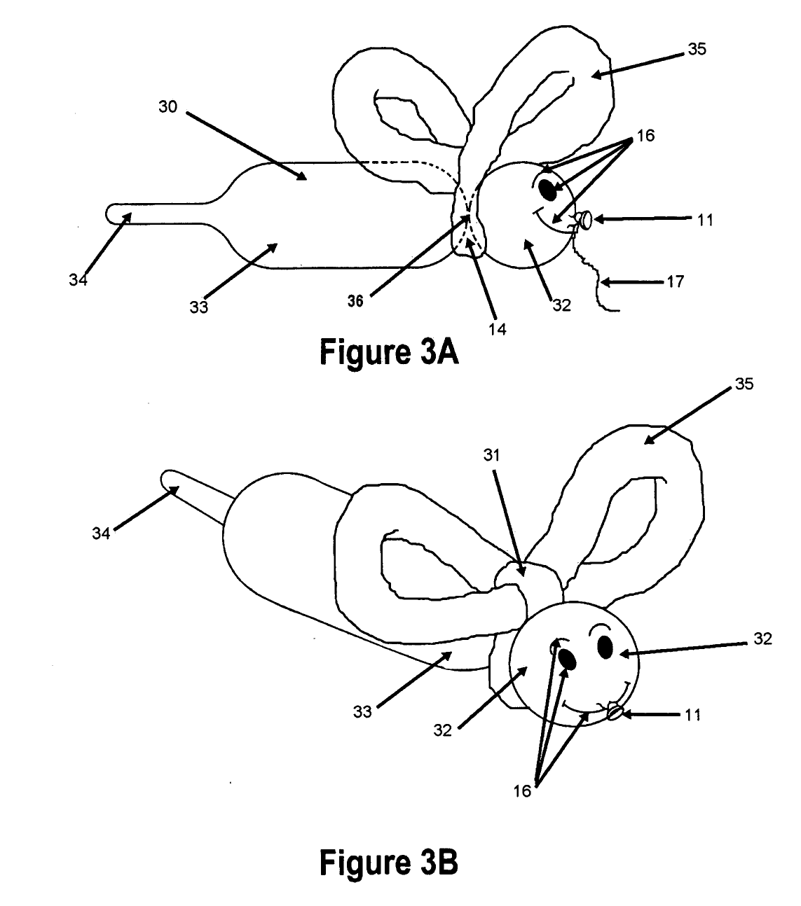

Referring now to FIGS. 3A and 3B, another embodiment of the present invention is shown. The composite structure may have a balloon body, shown in FIGS. 3A-3B as a cylindrical body 30. The cylindrical body of the embodiment shown comprises a head portion 32, a body portion 33 and a tail portion 34. The head portion 32 is formed by twisting part of the body portion 33 repeatedly, forming a generally circular head portion 32 separated from body portion 33 by a twisted portion 36, the twisted portion 36 being a narrow section of twisted balloon material. The tail portion 34 is formed during manufacture of the balloon body by substantially reducing the diameter of the cylindrical body 30. Cylindrical balloons similar to the balloon body shown in FIGS. 3A-3B are manufactured by Pioneer Balloon Company and by Tilly Balloons, and are often marketed as “Bee Bodies.” It should be understood that the cylindrical body 30 may be of a substantially cylindrical shape such as approximately cylindrical, may have varying diameters along its length, or may be teardrop shaped, without straying from the scope of the present invention. The cylindrical body 30 consists of a bag made of thin latex, or other light material including but not limited to Mylar, metallic coated film, or other thin, generally gas impermeable material.

The cylindrical body 30 may be inflated during construction of the composite structure by the supply of an inflation fluid such as air, lighter-than-air gas such as helium or hydrogen, water or other liquid, or a combination of gasses, a combination of liquids, or liquids and gasses. This inflation fluid is introduced through a neck portion 11 of the cylindrical body 30. The introduction of the inflation fluid may be performed manually by the user using air forced from the lungs, or by the aid of a pump, pressurized canister, water faucet, or other similar device capable of moving a fluid with substantial pressure so as to inflate the balloon body.

The neck portion 11 is constructed and arranged as a section of the balloon body with a substantially narrowed diameter and defines an aperture providing fluid communication between an inside of the balloon and the atmosphere. The neck portion thus creates a small channel for the inlet and outlet of inflation fluid to the balloon body. The neck portion 11 is constructed and arranged such that it creates a channel extending from the balloon body that may be sealed, preventing escape of the inflation fluid by tying-off creating a knot or balloon knot, fusing the neck portion 11 closed, or other sealing method capable of preventing a rapid escape of inflation fluid.

A facial portion 16 of the balloon body is located on an outer surface of the cylindrical body 30. Facial features may be imprinted on this facial portion 16. Facial features included on the facial portion 16 may include features such as hair, eyes, pupils, nose, mouth, eyebrows, and ears, among others. The facial portion 16 may have facial features imprinted on it manually by marker, pen, paint, or other writing implement, or the features may be imprinted by being printed, screened, or sprayed onto the facial portion of the balloon body. The facial portion 16 may be imprinted either before inflation, or after.

A chenille stem 14 may be wrapped around the cylindrical body 30. In the embodiment shown in FIGS. 3A-3B, the chenille stem 14 is wrapped around a region between the body portion 33 and the head portion 32 of the cylindrical body 30, where the diameter of the cylindrical body 30 is reduced because of the twisting employed to form the head portion 32. The chenille stem 14 is secured to the cylindrical body 30 by twisting two portions of the chenille stem 14 about each other, forming a knot 31. FIG. 3B shows this knot 31 as a bow knot, however any twisting of the chenille stem 14 that maintains the chenille stem 14 position will suffice. The chenille stem 14 is thus held in place by the knot 31 and the friction caused by the outward pressure of the cylindrical body 30 against the chenille stem 14. The knot 31 may be formed by manual manipulation by the user, automated twisting by machine, the chenille stem 14 may be twisted to form a knot 31 during manufacture, or the stem may have a pre-formed region to serve as a knot 31. In other embodiments, the chenille stem 14 may be held in position using adhesives such as glue or tape.

While forming the knot 31, the chenille stem 14 may be formed to resemble enhancements, including features such as wings, legs, or arms, among others, as the user may desire, to increase the realism and entertainment value of the composite structure. These enhancements may also be formed before or after the knot 31 is formed. The embodiment shown in FIGS. 3A and 3B comprises wings 35 formed by bending the chenille stem into a loop while creating the knot 31. The wings 35 may be created, for example, while creating the knot 31 by using long portions of the chenille stem 14 to create the knot 31, allowing for a substantial length of chenille stem 14 to remain free, i.e. not knotted. The substantial length of chenille stem 14 may then be bent as desired to form the wings 35, or other features, as the user may desire. The wings 35 may be formed by manual manipulation by the user, automated bending by machine, or the chenille stem 14 may be bent to form the wings 35 during manufacture.

A string 17 may be attached to the composite structure. The string may be attached to any part of the composite structure, such as portions of the cylindrical body 30, namely the head portion 32, the body portion 33 or the tail portion 34, to the neck portion 11, to the chenille stem 14, to the knot 31, or to the wings 35.

One embodiment of the present invention may involve the chenille stem being shaped as a skeleton, and the balloon bodies being shaped as an appendage (not shown). These appendages may include features such as eyes, nose, mouth, ears, head, flower, limbs, and the like. In this embodiment the balloon bodies may have facial portions that may be imprinted with facial features.

One embodiment of the present invention involves a kit for constructing the composite structure providing the elements necessary to assemble the composite structure. The kit form of the present invention provides elements of the composite structure, and allows a user to assemble the composite structure themselves. The kit may be particularly useful for activities such as arts and craft gatherings.

The kit may comprise at least one balloon body, and at least one chenille stem. In one embodiment, the kit may further comprise a marker, pen, paint or other marking implement for drawing features onto the face portion of the balloon body. In another embodiment, the kit may include a number of balloon bodies and chenille stems for complex composite structures. In another embodiment, the chenille stems may be pre-formed. In yet another embodiment the kit may include pre-made composite structures, in either deflated or inflated form. Further, the kit may include an instruction manual providing instructions and information about the use of the kit. In still another embodiment, the kit may include a balloon pump for inflation of the balloon body or bodies. In yet another embodiment, the kit may include scissors for cutting and sizing the chenille stems.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A composite structure comprising:
an inflated balloon body having a first surface portion and a second surface portion; and
a chenille stem being attached to the first surface portion of the balloon body, the chenille stem being shaped to resemble an enhancement.

2. The composite structure of claim 1 wherein the chenille stem is frictionally attached to the balloon body.

3. The composite structure of claim 1 further comprising a plurality of balloon bodies, and a plurality of chenille stems, the plurality of balloon bodies being attached together by an interlocking of the plurality of chenille stems.

4. The composite structure of claim 1 wherein the balloon body defines an aperture through a central axis, forming a blossom shaped balloon body.

5. The composite structure of claim 4 wherein the chenille stem is frictionally attached to the balloon body by having a central portion disposed through the aperture of the balloon body, the chenille stem having a curved shape to aid in frictional attachment.

6. The composite structure of claim 5 wherein the second surface portion of the balloon body is imprinted with a facial feature.

7. The composite structure of claim 6 wherein an end portion of the chenille stem is folded to create a hand.

8. The composite structure of claim 1 wherein the balloon body is shaped to be substantially spherical, and wherein the chenille stem is disposed around a circumference of the balloon body.

9. The composite structure of claim 8, wherein the second surface portion of the balloon body is imprinted with a facial feature, the second surface portion being positioned exclusively on one of the hemispheres of the balloon body divided by the chenille stem.

10. The composite structure of claim 9 wherein an end portion of the chenille stem is of a triangular shape to resemble an ear.

11. The composite structure of claim 1 wherein the balloon body is shaped to be substantially cylindrical, and wherein a head portion of the balloon body is separated from a body portion of the balloon body by a twisted portion of the balloon body.

12. The composite structure of claim 11 wherein the chenille stem is attached to the twisted portion of the balloon body.

13. The composite structure of claim 12 wherein an end portion of the chenille stem is shaped as a loop, to resemble a wing.

14. The composite structure of claim 13 wherein a portion of the balloon body has a substantially reduced circumference, forming a tail portion.

15. The composite structure of claim 13 wherein the second surface portion located on the head portion of the balloon body is imprinted with a facial feature.

16. A method of constructing a composite structure comprising the steps of:
inflating a balloon body with an inflation fluid;
attaching a chenille stem to the balloon body by disposing the chenille stem about a circumference of the balloon body, and twisting a first portion of the chenille stem about a second portion of the chenille stem;
imprinting at least one facial feature onto a surface of the balloon body; and
shaping an end portion of the chenille stem to resemble an enhancement.

17. The method of constructing a composite structure of claim 16 wherein the step of imprinting further includes the imprinting of a plurality of eyes, a nose, and a mouth by using a marker.

18. A kit for constructing a composite structure comprising:
a balloon body;
a chenille stem capable of attachment to the balloon body; and
an instruction manual containing instructions for attachment of the chenille stem to the balloon body.

19. The kit for constructing a composite structure of claim further comprising a marker for imprinting a facial feature onto a surface of the balloon body.

20. The kit for constructing a composite structure of claim 18 further comprising a balloon pump for inflating the balloon body with an inflation fluid.
